(19) United States
(12) Patent Application Publication
(10) Pub. No.: US 2016/0167793 A1
(43) Pub. Date: Jun. 16, 2016

(54) AIRBAG PROTECTION SYSTEM

(71) Applicant: AIRBUS GROUP SAS, BLAGNAC (FR)

(72) Inventor: Jean-Francois GENESTE, TOULOUSE (FR)

(21) Appl. No.: 14/970,570

(22) Filed: Dec. 16, 2015

(30) Foreign Application Priority Data
Dec. 16, 2014 (EP) 14307053.0

(51) Int. Cl. B64D 25/02; B60R 21/231

(52) U.S. Cl. CPC B64D 25/02; B60R 21/231; B64D 2201/00; B60R 2021/0093

(57) ABSTRACT

A protection system (15) includes an inflatable bag (16) connected to inflation elements able and intended to be activated so as to inflate the inflatable bag in the event of and/or upon the prediction of an impact. The inflatable bag (16) has a substantially annular overall shape when inflated. Such a protection system (15) is advantageously intended to protect the passengers in a helicopter.

### FIELD OF THE INVENTION

The present invention relates to a protection system using an inflatable cushion commonly referred to as an airbag.

The protection system may notably be used in all spheres of activity in which accidents occur as a result of a sharp deceleration of a vehicle due to a fall or a violent impact against a fixed or moving obstacle.

The invention finds for example an application in the landing of a helicopter by allowing, in the event of an emergency put-down, a landing that is more dependable and limits the damage caused to the helicopter and especially to its passengers.

### PRIOR ART

Recourse to airbags in vehicles which, as they deploy, set themselves between a passenger and the obstacle that the passenger could strike are known from the prior art.

To illustrate one example, mention may be made of helicopters which have airbags, referred to as floats, positioned near the usual landing means and which are built into the helicopter. The floats are inflated prior to the landing of the helicopter to replace the landing systems when the latter are deficient.

Such floats advantageously make it possible to solve the problem of the emergency set-down of helicopters by allowing the damaged helicopter to be put down while at the same time avoiding coming into direct and sharp contact with the ground.

However, in an impact with a vertical main component, such airbags are unable to prevent the engine and blades of the helicopter, under the force of the impact, collapsing onto the cabin, crushing it, which would have the effect of causing significant if not irreparable damage to the helicopter, and of injuring the passengers in the cabin.

### SUMMARY OF THE INVENTION

It is an object of the present invention to alleviate the disadvantages of the protection systems proposed by the prior art, particularly those set out hereinabove, by proposing a protection system which can be adapted to suit the problem set of any type of vehicle (space, land vehicle) able to resist the compression forces applied to it without penalising the weight of the vehicle.

Thus the present invention proposes a protection system which comprises an inflatable bag connected to inflation means able and intended to be activated so as to inflate the said inflatable bag in the event of and/or upon the prediction of an impact.

The bag has a substantially annular overall shape when inflated.

substantially annular overall shape means that the inflatable bag has substantially the shape of a ring, circular or not.

When the inflatable bag has for example a circular ring shape, the inflatable bag has the shape of a torus, with an internal radius and an external radius.

Because of its substantially annular overall shape, the inflatable bag has a smaller volume than existing inflatable bags and therefore a lower mass.

The protection system according to the invention thus advantageously has a geometry that allows it to withstand the external pressure forces that may be applied to it.

Such a protection system is advantageously intended to be incorporated into a helicopter, into a space probe or even into an aircraft.

According to some preferred embodiments, the invention also has the following features, considered separately or in each of the technically functional combinations thereof.

According to one particular feature of the invention, the inflatable bag has a T-shaped cross section when inflated. The cross section is defined in a plane passing through an axis of revolution of the inflatable bag. The inflatable bag has an uniform cross section.

Because of their T-shaped cross section, the inflatable rings have a smaller volume than inflatable rings of typically circular cross section and therefore a smaller mass, chiefly because, for the same internal fluid pressure, inflatable rings of T-shaped cross section have a smaller volume.

According to one particular feature of the invention, the inflatable bag is made of a structure of interlaced filaments.

According to some particular embodiments of the invention, the protection system comprising a plurality of inflatable bags and connecting elements, two inflatable bags being connected by at least one connecting means, so as to form a mesh.

According to one particular embodiment of the invention, a connecting element is an inflatable connecting element.

In one embodiment, the connecting element has a T-shaped cross section when inflated.

According to one particular feature of the invention, an inflatable bag and an adjacent connecting element each have an internal volume, the said at least two internal volumes communicating with one another.

According to one particular alternative form of the invention, all the inflatable bags and all the connecting elements each have an internal volume, all the internal volumes communicating with one another.

According to one particular feature of the invention, the protection system comprises two inflation means configured to inflate at least two inflatable bags independently.

According to one particular feature of the invention, an inflatable bag has an internal volume divided into two independent chambers that inflate/deflate selectively relative to one another.

The invention also relates to a helicopter. Said helicopter comprises at least one protection system according to at least one of the embodiments or features thereof extending, when inflated, from an internal face of a cabin, preferably circumferentially.

Such a configuration makes it possible, in the event of an impact, notably one with a vertical component, to limit the crushing of the cabin. An enveloping effect is also obtained that makes it possible to reduce the risk of direct contact between passengers and the internal face of the cabin.

The invention also relates to a space probe. The said space probe comprises at least one protection system according to at least one of the embodiments or features thereof extending, when inflated, from an external face.

Such a configuration makes it possible to slow and deaden the impact of the space probe as it lands, the inflatable bags being designed to absorb the energy of the impact on landing.

The protection system, because of the substantially annular overall shape of the inflatable bags advantageously allows a smaller volume of fluid to be carried onboard the space probe, thereby making the overall mass of the said space probe lighter.

The invention also relates to an aircraft. The said aircraft comprises at least one protection system according to at least one of the embodiments or features thereof extending, when inflated, from a radome or an engine cone.

Such positioning makes it possible to halt any in-flight projectiles such as birds either in order to maintain the aerodynamic role of the radome and protect the radar situated inside the radome or to protect the engines.

### INTRODUCTION TO THE DRAWINGS

The invention will be described more specifically now in the context of some preferred embodiments, which are not in any way limiting, depicted in FIGS. 1 to 5 in which:

FIG. 1 is a schematic perspective view of a helicopter equipped with a protection system, depicted in dotted line, according to one embodiment of the invention;

FIG. 2 is a schematic side view of the helicopter of FIG. 1;

FIG. 3 is a schematic depiction of a protection system applied to the protection of a space probe, according to one embodiment of the invention;

FIG. 4 is a schematic depiction of a protection system applied to the protection of a space probe, according to another embodiment of the invention;

FIG. 5 is a schematic depiction of a protection system applied to the protection of a radome of an aircraft, according to one embodiment of the invention.

### DETAILED DESCRIPTION OF EMBODIMENTS OF THE INVENTION

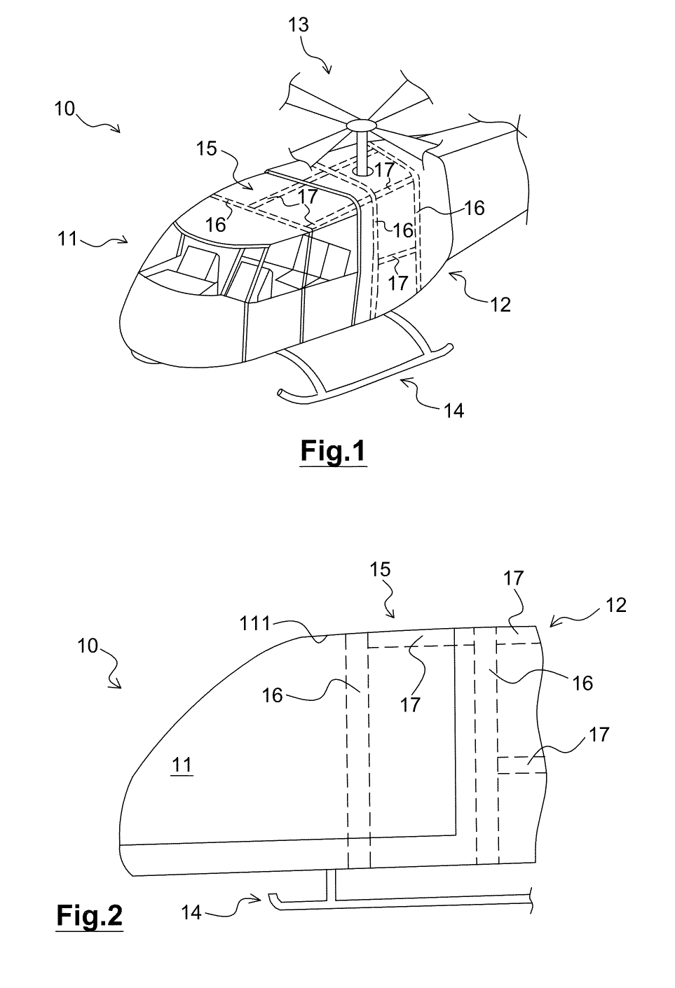

Examples of protection systems according to the invention are now described for three distinct applications illustrated using FIGS. 1 to 5.

Protection System 15 for a Helicopter (FIGS. 1 and 2)

In the conventional way, a helicopter 10 is essentially formed:
of a cabin 11 to accommodate a pilot and passengers,
of a fuselage 12,
of a wing structure 13 and of an associated power train,
of landing means 14.

It is common practice to provide various protections against the impacts that the helicopter and the passengers may experience. In particular, the helicopter 10 is generally provided with passenger safety means such as safety harnesses (which have not been depicted).

According to the invention, a protection system 15 comprising at least one inflatable bag 16, also referred to as an airbag, is provided. This protection system 15 is advantageously there to become interposed, as it deploys, between the passengers and the fuselage 12 which may strike the passengers during an impact with the ground.

In a preferred exemplary embodiment, the protection system 15 comprises a plurality of inflatable bags 16.

In the example of FIGS. 1 and 2, for the sake of clarity, only three inflatable bags 16, depicted in dotted line, are illustrated.

Each inflatable bag 16 has a substantially annular overall shape when inflated and has an internal volume.

In the state of rest, namely before inflation is triggered, each of the inflatable bags 16 takes the form of a strip extending, for preference, circumferentially from an internal face 111 of the cabin 11. Each inflatable bag 16 thus folded has a relatively small thickness so as not to reduce the volume of the cabin 11.

For preference, each inflatable bag 16 is positioned near a stringer that forms part of the structure of the fuselage 12.

An inflatable bag 16 is designed to be inflated by the introduction of a fluid, into its interior volume, via inflation means (which have not been depicted). These inflation means are conventional in themselves in their form and in their operation and are not described in further detail in this description.

In one exemplary embodiment, the inflatable bag 16 is inflated with air, this having a low mass per unit volume, but it may also be conceivable to fill it with another fluid, such as helium or dinitrogen for example.

In one embodiment of an inflatable bag 16, the said inflatable bag is made from a structure with interlaced filaments, of the woven mesh type, the mesh of which is chosen so as to withstand internal pressure forces. The said structure is covered by a coating impervious to the inflation fluid.

In another embodiment of an inflatable bag 16, the said inflatable bag 16 is made from a structure with interlaced filaments of the woven mesh type, into which polymer vapours are injected which settle on the structure and polymerize into the form of a very fine film so as to fill the open portions of the interlaced filament structure.

In both of the above embodiments, the interlaced filament structure comprises, for example, filaments made of aramide, such as Kevlar®.

Such structures advantageously make it possible not to add excessive additional weight to the helicopter.

In one preferred embodiment, when inflated, the inflatable bag 16 has, in a plane passing through an axis of revolution of the inflatable bag 16, a T-shaped cross section with a head and a foot.

In order to obtain a T-shaped cross section, the inflatable bag 16, initially generally of circular or oval cross section, may be deformed into a T shape by stitching or needling threads, for example made of Kevlar®.

Advantageously, such a cross section of inflatable bag 16 makes it possible, in comparison with a conventional circular or oval cross section of inflatable bag 16, to achieve better compression strength for a lower inflated internal volume, and therefore a lower mass.

For preference, the foot of the T has a length that is as long as possible. The length of the foot is dependent on the external pressure applied to the inflatable bag 16 in the knowledge that, in general, the longer the foot of the T the higher will be its resistance to the external pressure applied.

The head advantageously allows an increase in an area of contact of the inflatable bag 16 with the fuselage 12. In one example of sizing, the head has a width substantially equal to a thickness of the foot of the T.

The present invention is not restricted to the example of an inflatable bag 16 having a T-shaped cross section as described and illustrated. A person skilled in the art will be able to adapt the invention to cross sections of inflatable bag 16 that have not been described and that allow compression to be withstood in a minimum volume, and therefore with a mass of fluid in the internal volume at least equivalent to that of the inflatable bag 16 of T-shaped cross section.

In one example of a cross section, an I-section may be contemplated.

In one embodiment of the inflatable bag 16, the internal volume of the inflatable bag 16 is divided into at least two independent chambers. The at least two independent chambers inflate and/or deflate selectively relative to one another, for example by means of a valve. Thus, to prevent the wing structure 13 from collapsing against the fuselage 12 in the event of an impact having a vertical component, one solution might be not to inflate at least one chamber of several inflatable bags 16, so as to cause a lever arm effect allowing the helicopter to tip sideways and throw the wing structure directly onto the ground.

The protection system 15 may further comprise a connecting element 17 connecting two adjacent inflatable bags 16. Each connection element 17 is connected, at two opposite ends, to two inflatable bags 16.

The connecting elements 17 are arranged in such a way as to prevent a geometric deformation of the protection system 15 in space, under the effect of external pressure forces applied to the said protection system 15, for example in the event of an impact that has a vertical component.

The choice of the number of connecting elements 17 and of how they are positioned between the plurality of inflatable bags 16 so as to prevent, in the plane, a geometric deformation of the protection system 15 under the effect of the external pressure forces applied is within the competence of the person skilled in the art.

In one embodiment, the connecting elements 17 connects the inflatable bags 16 in the way illustrated in FIGS. 1 and 2 to form a mesh.

Thus, on deployment, the connecting elements 17 prevent the inflatable bag 16 from parting from one another.

The protection system 15 thus affords protection against longitudinal and lateral and/or composite impacts.

In the example of FIG. 1, for the sake of clarity, just four connecting elements 17, depicted in dotted line, have been illustrated. In FIG. 2, only three connecting elements 17, depicted in dotted line, have been illustrated.

Each connecting element 17 is, for example, positioned near a frame which, with the stringers, forms the structure of the fuselage 12.

In one preferred embodiment, a connecting element 17 is an inflatable element.

In one embodiment, the connecting element 17 is an element that is tubular when inflated. The connecting element 17 may have a T-shaped cross section.

In an alternative form of embodiment, the connecting element 17 is an element of substantially annular overall shape when inflated. The connecting element 17 may have a T-shaped cross section.

Whatever the embodiment, in the state of rest, each of the connecting elements 17 takes the form of a strip extending preferably from the internal face 111 of the cabin 11. Each connecting element 17 thus folded has a relatively small thickness so as not to reduce the volume of the cabin 11.

Whatever the embodiment, the inflatable bags 16 and the inflatable connecting elements 17 are connected in such a way that the internal volumes of at least one inflatable bag 16 and one adjacent inflatable connecting element 17 communicate with one another and that the same fluid circulates through the internal volumes and inflates them. Inflation is performed by a single inflation means.

For preference, the inflatable bags 16 and the inflatable connecting elements 17 are configured in such a way that the internal volumes of all the inflatable bags 16 and the inflatable connecting elements 17 communicate with one another so that the same fluid circulates through all the internal volumes and inflates them. Thus, a single inlet and a single inflation means is needed to inflate the protection system 15.

Alternatively, each inflatable bag 16 and each inflatable connecting element 17 is configured to be inflated by a specific inflation means. Triggering in this case may be more selective and it may thus be possible to inflate one or more inflatable bags 16 or connecting elements 17 on the side of the impact first then inflate the rest of the inflatable bags 16 and of the connecting elements 17 in a predetermined chronological sequence. The triggering of the inflation is performed under predetermined conditions.

The predetermined conditions may for example be the detection of an impact or of a deceleration above a predetermined threshold.

This triggering may be brought about by a control unit (not depicted) associated with detection means and able to interpret deceleration data or any other data.

For preference, the detection means are automatic; they may for example call upon an accelerometer. The detection means may be specific to the protection system 15 or alternatively may form part of the helicopter equipment.

Alternatively, triggering may be manual, by the pilot or a passenger pressing a push button.

Initial arming of the protection system 15 may be needed in order to allow subsequent triggering of the inflation and avoid unwanted triggering. This arming may be performed for example by closing an electric contact switch incorporated into an inflatable bag 16.

The protection system 15 may comprise sleeves in which the inflatable bags 16 and the inflatable connecting elements 17 are arranged, folded, in the state of rest.

Each sleeve is, for example, anchored to the fuselage 12 of the helicopter, at the stringers and frames, but the case could be otherwise. The anchoring of the sleeves to a structural part of the helicopter may adopt various forms not described in detail but within the competence of those skilled in the art.

The inflatable bags 16 and the connecting elements 17 are enclosed in a respective sleeve so as not to be accessible and so as to be protected from the environment.

As an alternative, one single sleeve for all of the inflatable bags 16 and connecting elements 17 is used.

In an alternative form of embodiment, the inflatable bags 16 and the connecting elements 17 may take the place of the frames and stringers of the structure of the fuselage 12. The inflatable bags 16 and the connecting elements 17 thus form structural parts of the helicopter.

The advantage with such a configuration lies in the dual functionality of the inflatable bags 16 and of the connecting elements 17.

On the one hand, the said inflatable bags 16 and the said connecting elements 17 are configured to hold themselves in an inflated state, at a predetermined internal pressure, so as to withstand the stresses of use (corresponding to the loading applied to the fuselage structure under normal use, for example, during the various phases of flight, landing, take off, etc) to which a structural component as such is subjected during operation. Maintenance of the pressure-monitoring type may be programmed.

On the other hand, in the event of the detection means detecting an impact, the inflatable bags 16 and the connecting elements 17 may act like an airbag. The internal pressure in the inflatable bags 16 and the connecting elements 17 is suddenly increased by a predefined pressure in order to allow the fuselage 12 to withstand the said impact. It is also possible, where appropriate, to tolerate variations in the volume of the inflatable bags.

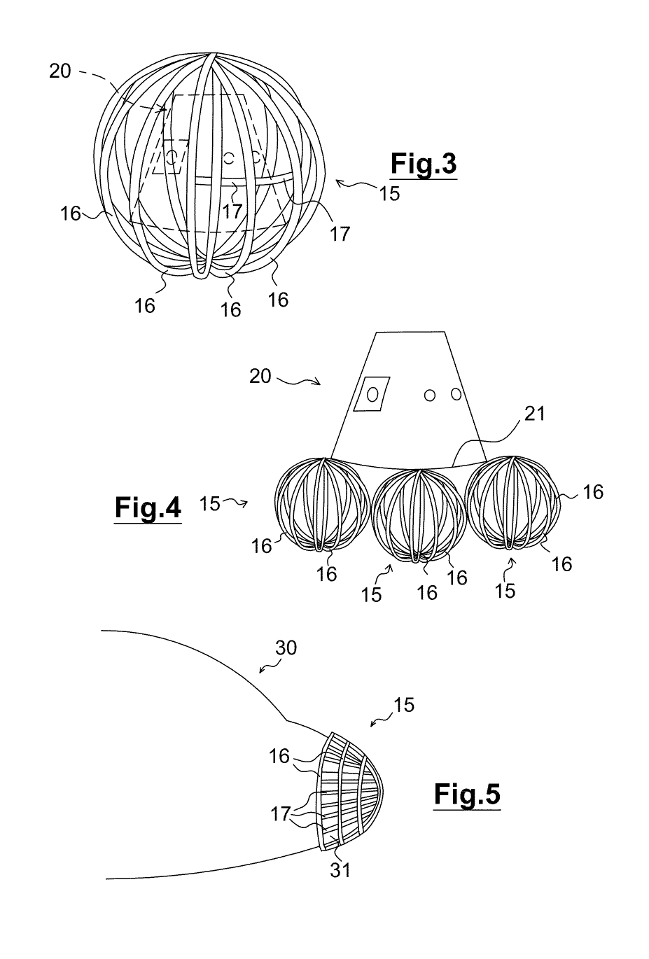

Projection System 15 for a Space Probe (FIGS. 3 and 4)

The protection system 15 can also be applied to a space probe 20, as illustrated in FIGS. 3 and 4, chiefly to deaden the impact and perform a slowing function as it lands.

In one example of a setup the protection system 15 has a collection of inflatable bags 16, each of substantially annular overall shape when inflated, arranged in such a way as to form meridians of revolution of a sphere.

What is meant by a meridian is a peripheral circle joining the axial vertices of a sphere.

All or some of the internal volumes of the inflatable bags 16 may be placed in communication with one another and inflated by a single inflation means. As an alternative, the internal volumes of the inflatable bags 16 are not placed in communication with one another but are inflated independently of one another, each by its own specific inflation means.

In an alternative form of embodiment, in order to consolidate this arrangement, the inflatable bags 16 are connected to one another by inflatable connecting elements 17, for example arranged in such a way as to embody at least one parallel of a sphere. This for example gives a trapezoidal mesh structure at the surface of the sphere.

The inflatable connecting elements 17 may be placed in communication with the inflatable bags so as to be inflated by the same inflation means.

In the state of rest, each of the inflatable bags 16 and of the connecting elements 17 if present, takes the form of a strip placed at an external face of the space probe.

When inflated, the arrangement of inflatable bags 16, possibly of connecting elements 17, surrounds the space probe, as illustrated in FIG. 3.

It is clear that the protection system 15 may also comprise a plurality of such assemblies arranged on at least one external face of the space probe, as illustrated in FIG. 4.

Inflation of the protection system 15 according to at least one of the embodiments described hereinabove is triggered by a proximity detector.

In order to perform the function of slowing and deadening the impact of the space probe 20 upon landing, the inflatable bags 16 (and possibly the inflatable connecting elements 17, if present) of the protection system 15 are designed to absorb the energy of the impact.

According to one advantageous aspect, the energy for deadening the impact of the space probe 20 may be absorbed by one of the following means:
vents in the inflatable bags (and possibly the inflatable connecting elements 17, if present), or a pressure limiting valve, which allow partial evacuation of the fluid while the impact is being deadened,
the inflatable bags (and possibly the inflatable connecting elements 17, if present) may be made fully or partially from porous fabric, thereby likewise allowing partial evacuation of the fluid while the impact is being deadened,
the inflatable bags (and possibly the inflatable connecting elements 17, where present) may comprise a deformable portion capable of deforming elastically or plastically in order to absorb energy.

Unlike the existing protection systems, which consist of solid spheres which are filled with a large quantity of fluid with a view to landing, the protection system 15 according to at least one of the embodiments described hereinabove advantageously requires a smaller volume of fluid to afford identical protection, and therefore a lower inflation time and therefore a shortened response time. The volume of fluid to be carried onboard the space probe is reduced and so the mass of the said space probe is likewise reduced as is the quantity of fuel needed to transport the space probe.

Protection System 15 for an Aircraft (FIG. 5)

The protection system 15 can also be applied to an aircraft 30, chiefly to resist birdstrike, whether on the radome or on an engine cone.

In one example arrangement, the protection system 15 has an assembly of inflatable bags 16, each of substantially annular overall shape when inflated, and inflatable connecting elements 17. The inflatable bags 16 have decreasing diameters and are connected to one another by inflatable connecting elements 17 so as to embody a cone or a cone frustum.

All or some of the internal volumes of the inflatable bags 16 and of the inflatable connecting elements 17 may be placed in communication with one another and inflated by a single inflation means. As an alternative, the internal volumes of the inflatable bags 16 and of the inflatable connecting elements 17 are not placed in communication with one another and are inflated independently of one another, each by a specific inflation means.

In the state of rest, each of the inflatable bags 16 and of the connecting elements 17 takes the form of a strip placed on an external face of the radome or on the cone of an engine.

When inflated, the inflatable bags 16 and the connecting elements 17 surround the radome, as illustrated in FIG. 5, or surround an engine cone.

The protection system 15 is produced in such a way as to form a small-mesh net, namely a net the meshes of which are close enough together to keep birds out.

When the protection system 15 is positioned on the cone of an engine, given that it takes the form of a fine mesh net, it advantageously causes very little destruction to the intake of air into the engines.

Inflation of the protection system 15, according to at least one of the embodiments described hereinabove, is triggered by a proximity detector.

The above description clearly illustrates that, through its various features and the advantages thereof, the present invention achieves the objectives it has set itself. In particular, it proposes a protection system which can be adapted to suit the problem set of any type of vehicle (space, land, etc. vehicles), is resistant to the compression forces applied to it without penalizing the weight of the vehicle. The invention also advantageously makes it possible to improve the level of protection afforded to the passengers.

1-12. (canceled)

13. Protection system comprising an inflatable bag connected to inflation means able and intended to be activated so as to inflate the inflatable bag in the event of and/or upon the prediction of an impact,
wherein the inflatable bag has a substantially annular overall shape when inflated.

14. The protection system according to claim 13, wherein the inflatable bag (16) has a T-shaped cross section when inflated.

15. The protection system according to claim 13, wherein the inflatable bag (16) is made of a structure of interlaced filaments.

16. The protection system according to claim 13, comprising a plurality of inflatable bags and connecting elements, two inflatable bags being connected by at least one connecting means.

17. The protection system according to claim 16, wherein a connecting element is an inflatable connecting element.

18. The protection system according to claim 17 wherein an inflatable bag and an adjacent connecting element each have an internal volume, the at least two internal volumes communicating with one another.

19. The protection system according to claim 17 wherein all the inflatable bags and all the connecting elements each have an internal volume, all the volumes communicating with one another.

20. The protection system according to claim 17 comprising two inflation means configured to inflate at least two inflatable bags independently.

21. The protection system according to claim 13 in which an inflatable bag has an internal volume divided into two independent chambers that inflate/deflate selectively relative to one another.

22. Helicopter which comprises at least one protection system according to claim 13 extending, when inflated, from an internal face of a cabin.

23. Space probe, which comprises at least one protection system according to claim 13 extending, when inflated, from an external face.

24. Aircraft, which comprises at least one protection system according to claim 13 extending, when inflated, from a radome or from an engine cone.
